(19) United States
(12) Patent Application Publication
(10) Pub. No.: US 2017/0166792 A1
(43) Pub. Date: Jun. 15, 2017

(54) Dust Control Formulations

(71) Applicant: Henry Company, LLC, El Segundo, CA (US)

(72) Inventor: Amba Ayambem, Kimberton, PA (US)

(21) Appl. No.: 15/378,777

(22) Filed: Dec. 14, 2016

Related U.S. Application Data
(60) Provisional application No. 62/266,778, filed on Dec. 14, 2015.

(51) Int. Cl. C09K 3/22; C04B 24/08; C10L 5/24

(52) U.S. Cl. CPC C09K 3/22; C10L 5/24; C04B 24/08; C10L 2250/04; C10L 2290/18

(57) ABSTRACT

This disclosure describes formulations and methods for dust control, for example, coal topping, a term which refers to the application of liquid products to the top of coal loads, such as those in open topped coal hopper railcars as commonly used today to transport coal. Disclosed herein are wax-based emulsion formulations that accomplish dust control during industrial operations in which dust handling is required.

### CROSS REFERENCE TO RELATED APPLICATIONS

This application claims the benefit of U.S. Provisional Patent Application No. 62/266,778, filed on Dec. 14, 2015, which is incorporated by reference herein in its entirety. This application is also related to U.S. patent application Ser. Nos. 15/197,047 and 15/274,258, filed on Jun. 29, 2016 and Sep. 23, 2016, respectively.

### TECHNICAL FIELD

The present invention relates to dust control compositions. More specifically, the invention is directed to dust-inhibiting concentrates and other solutions containing wax emulsions. This disclosure describes formulations and methods for dust control, for example, coal topping, a term which refers to the application of liquid products to the top of coal loads, such as those in open topped coal hopper railcars as commonly used today to transport coal. Disclosed herein are wax-based emulsion formulations that accomplish dust control during industrial operations in which dust handling is required.

### BACKGROUND

Many industrial operations create fugitive dust. Because it can be airborne, fugitive dust is an environmental and health hazard and in some cases, even a fire hazard. Airborne dust can also mean loss of usable material. Also, the airborne particles are highly pervasive and can enter the nose, lungs, eyes and even the pores of the skin. Industrial operations requiring dust prevention include dumping of material, transportation, transfer point operation, stockpiling, storage, re-claiming, conveyoring, shearing, continuous mining, crushing, screening and sifting, drying, packaging and filling.

All types of dust including soil particles, industrial products, by-products and waste, coal dust, road dust and many others present hazards. Some examples of particulate materials that produce dust include for example, ground limestone (10 to 1000 μm); fly ash (10 to 200 μm); coal dust (1 to 100 μm); cement dust (3 to 100 μm); carbon black (0.01 to 0.3 μm); and pulverized coal (3 to 500 μm).

For example, the high speed transportation of coal by rail may cause loss of fine coal particles. In fact, coal trains are known as “black snakes.” The name aptly describes the miles of uncovered rail cars bearing the black cargo as they slither along the tracks. During the journey from coal mines to their final destinations, coal trains shed plumes of coal dust from the tops of the train cars. As the dust spews from the rail cars, it fills the surrounding air. with harmful substances like mercury, lead, cadmium, arsenic, manganese, beryllium, and chromium. When the dust settles, these substances are deposited in soil and water, harming plant, animal, and marine life.

Both train vibration and airspeed (from wind or due to the speed of train) can lift particles from exposed coal making them airborne and depositing them along the right-of-way and transporting them by wind considerable distances. In addition to environmental hazards, health hazards and product loss, coal dust lost during transportation can also damage transportation infrastructure. Environmental consequences from coal dust are also rooted in railroad safety concerns. Coal dust accumulation in the ballast can destabilize the tracks and contribute to derailments. Derailments impact the environment because the overturned train can spill locomotive fuel and dump thou-sands of pounds of coal and coal dust, resulting in soil and water contamination.

Fugitive dust problem avails itself to two solutions: (1) lowered dust creation; and (2) dust control through prevention, suppression, capture, or removal.

This invention relates to the second solution, that is, dust control. Dust control can be approached in four ways: (1) using wet systems that use water sprays to prevent dust or capture airborne dust; (2) using enclosures to contain dust; (3) using ventilation systems/exhaust systems to remove dust; (4) using a combination of these techniques. More specifically, this invention relates to a novel wax-based emulsion formulations in wet spray systems that can assist in dust control.

Halide brines, comprising one or more dissolved or suspended salts in water, usually halide salts, especially chloride salts, particularly calcium chloride, magnesium chloride and other alkali metal and alkaline earth metal salts, are used extensively for inhibiting dust on a variety of surfaces including such uses as dust control of roadways, paved areas, bridges and the like as well as for inhibiting dust on surfaces of bulk materials, such as coal, coke, limestone and minerals. They are also used for dust control, especially during dry weather during the handling and transportation of dust-producing bulk materials, such as coal, coke and limestone.

Aqueous solutions of these halides are known to corrode metals and cause scaling or surface damage to concrete. For example, heavy use of road deicers can result in serious damage to steel, particularly autos and other vehicles, as well as rapid deterioration of steel reinforcing rods in poured concrete roadways and bridges. The halides used for dust control of bulk materials such as coal or other minerals often cause corrosive deterioration of the materials-handling equipment, rail cars and other container carriers.

In accordance with the present invention, it has been found that a formulation comprising wax emulsions resists absorption into pores of coal and other mineral surfaces, including soil, so that after drying into a continuous or discontinuous film, the wax emulsion will provide later dust control, as well as exhibiting dust control and anti-corrosion properties upon later wetting with water.

The composition of the present invention addresses the above discussed problems of dust generation. The emulsion of the present invention comprising colloidally-protected, wax-based micro-structure can be added to a water based spray system that can then be used for spraying on to the particulate material, for example, coal, to control the dust.

### SUMMARY

This invention relates to a method for controlling dust on a surface of a bulk material, comprising:

(I) preparing a dust control formulation (DCF) comprising a dust reduction additive (DRA) emulsion comprising colloidally-protected wax-based (CPWB) microstructures; and

(II) applying said dust control formulation to said surface of said bulk material in an amount effective for dust control.

This invention also relates to the above method, wherein said dust control formulation is applied by sprinkling, and/or a spray nozzle.

This invention further relates to the above methods, wherein said dust control formulation further comprises a first water.

This invention also relates to the above methods, wherein said CPWB microstructure comprises:

(A) a wax core,

wherein said wax core comprises a paraffin component and a non-paraffin component,

wherein said paraffin component comprises at least one linear alkane wax defined by the general formula CnH2n+2, where n ranges from 13-80,

wherein said non-paraffin component comprises at least one wax selected from the group consisting of animal-based wax, plant-based wax, mineral wax, synthetic wax, a wax containing organic acids and/or esters, anhydrides, an emulsifier containing a mixture of organic acids and/or esters, and combinations thereof; and

(B) a polymeric shell,

wherein said polymeric shell comprises at least one polymer selected from polyvinyl alcohol, polyvinyl alcohol copolymers, polyvinyl alcohol terpolymers, polyvinyl acetate, polyvinyl acetate copolymers, polyvinyl acetate terpolymers, cellulose ethers, polyethylene oxide, polyethyleneimines, polyvinylpyrrolidone, polyvinylpyrrolidone copolymers, polyethylene glycol, polyacrylamides and poly (N-isopropylamides), pullulan, sodium alginate, gelatin, starches, and combinations thereof.

In one embodiment, this invention further relates to above methods, wherein said polymeric shell comprises polyvinyl alcohol.

In yet another embodiment, this invention further relates to above methods, wherein said DCF further comprises a binder; a preservative; a rheology modifier; and/or a surfactant.

In one embodiment, this invention further relates to above methods, wherein:

said binder is selected from polyvinyl acetate, polyvinyl alcohol, ethylene vinyl acetate co-polymer, vinylacrylic copolymer, styrenebutadiene, polyacrylamide, acrylic polymers, latex, natural starch, synthetic starch, casein, and combinations thereof.

In another embodiment, this invention further relates to above methods, wherein said dust-reduction additive emulsion further comprises a second water; a base; and a dispersant.

In one embodiment, this invention further relates to above methods, wherein said dispersant is selected from a dispersant having sulfur; a dispersant having a sulfur-containing group in the compound; sulfonic acid (R—S(═O)2-OH); sulfonic acid salts, wherein the R groups is functionalized with hydroxyl, or carboxyl; lignosulfonate; lignosulfonic acid; naphthalene sulfonic acid; sulfonate salt of lignosulfonic acid; sulfonate salt of naphthalene sulfonic acid; derivatized ligno-sulfonic acid; derivatized naphthalene sulfonic acid; functionalized lignosulfonic acid; functionalized naphthalene sulfonic acid; magnesium sulfate; polycarboxylate; ammonium hepta molybdate; combination of ammonium hepta molybdate and starch; alkyl quaternary ammonium; montmorillonite clay; non-ionic surfactants; ionic surfactants; zwitterionic surfactants; and mixtures thereof.

In another embodiment, this invention further relates to above methods, wherein said base is selected from monoethanol amine; diethanol amine; triethanol amine; imidazole; potassium siliconate; and combinations thereof.

Furthermore, this invention further relates to above methods, wherein the weight of said dust reduction additive emulsion is in the range of from about 0.01% to about 20% by weight of said dust control formulation.

In one embodiment, this invention further relates to above methods, wherein the weight of said dust reduction additive emulsion is in the range of from about 0.1% to about 10% by weight of said dust control formulation.

In one embodiment, this invention further relates to above methods, wherein said dust control formulation further comprises at least one component from a silicone, a siliconate, a fluorinated compound, a stearate, or a combination thereof.

In another embodiment, this invention relates to the above methods, wherein the silicones, siliconates, fluorinated compounds, or stearates are selected from the group consisting of metal siliconate salts, potassium siliconate, poly hydrogen methyl siloxane, polydimethyl siloxane, stearate-based salts, and combinations thereof.

In yet another embodiment, this invention further relates to above methods, wherein said dust control formulation is applied to the surface of said bulk material at the rate of from about 0.001 to about 5.0 gallon per square yard for controlling dust.

In one embodiment, this invention further relates to above methods, wherein said bulk material is coal, limestone, fly ash, cement, carbon black, coke, or mineral material.

In another embodiment, this invention further relates to above methods, wherein said bulk material is coal, and said dust control formulation is applied the top of said coal load in an open-topped, coal-hopper railcar, used for transporting coal.

This invention also relates to a concentrated dust control formulation, suitable for dust control upon dilution with water consisting essentially of water and about 5-80% weight of dust control additive emulsion comprising colloidally-protected wax-based (CPWB) microstructures.

### BRIEF DESCRIPTION OF THE DRAWINGS

The disclosed aspects will hereinafter be described in conjunction with the appended Drawings, provided to illustrate and not to limit the disclosed aspects, wherein like designations denote the elements.

FIG. 1 illustrates an example process of one embodiment of the disclosure.

FIG. 2 describes the particle model of a unitary wax particle that has been stabilized in the colloidal dispersion.

### DETAILED DESCRIPTION OF ILLUSTRATIVE EMBODIMENTS

The terms “approximately”, “about”, and “substantially” as used herein represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

The surprising discovery in the method of this invention is the effect of improved and long-lasting dust control and corrosion-inhibiting properties resulting from the presence of CPWB wax emulsion applied to various surfaces. Any surface exposed to dust-producing conditions can benefit from the method described herein.

Typical surfaces that require treatment for exposure to dust-yielding conditions are mineral, e.g., coal mines, coal, coke or limestone being transported by rail car, roadways, pavements, paved and unpaved open areas such as stock yards, bridges and the like. Coal, coke, limestone and other minerals may also produce dust that must be contained so as to limit pollution of the environment.

In accordance with a preferred embodiment of the methods described herein, the solution of CPWB wax emulsion in water is used to bind dust particles to larger particles, particularly on mineral, e.g., coal, mine floors and on coal during transport via uncovered rail cars. On mineral mine floors and as a surface covering for coal and other dust-producing minerals being transported in uncovered rail cars, the CPWB wax emulsion preferably has a concentration of about 0.1 wt. % to about 2 wt. % to bind smaller mineral particles to larger mineral particles. The CPWB wax emulsion coating resists absorption of the solution into the pores of the larger mineral particles and the CPWB wax emulsion absorbs water from the atmosphere and resists water evaporation to maintain the binding capability of the CPWB for continued binding of smaller mineral particles to larger mineral particles, even during movement and settling during transport.

If repeated applications of the CPWB wax emulsion solution are needed, such as on a roadway surface during construction, the CPWB wax emulsion concentration increases with each application to maintain the soil surface damp for an unexpectedly long period of time, e.g., about four times or more as long as using water only. The CPWB wax emulsion compositions described herein can be applied as CPWB wax emulsion in water. Alternatively, the composition can be provided as a slurry containing wax emulsion.

In the method of dust control, the DCF is applied to a surface of the material requiring dust control. One preferred rate of application is from about 0.001 to 5.0 gallons of admixture per square yard of surface treated. Rates vary according to the surface receiving the application. With unpaved roads, for example, the rate of application can be adjusted within a preferred range of 0.1 to 1.5 gallon of blend to one square yard of road. Treatment rates of application for other surfaces are known in the art.

The admixture can be applied to the surfaces of roads, bridges or bulk substances carried in open containers by any of several methods known in the art. One preferred method is sprinkling of the admixture solution over the surface requiring freeze conditioning or dust control. Another preferred method is spraying the admixture by nozzles, preferably pressurized nozzles, so that the mechanical action of the spray provides complete coverage of the admixture into unpaved road surfaces, coal, coke, limestone, and the like. Other known methods can be used to apply the admixture.

### GENERAL EMBODIMENTS

There are several constraints that apply to a dust control formulation such as a coal topper formulations. A tensile strength high enough to resist cracking when subjected to shocks and wind during transport is preferred. For the same reason, greater flexibility is also preferred. Due to the cost of water, a low water requirement is preferred. A relatively higher depth of penetration, which is directly related to the viscosity of the coal topper formulation, is preferred to bind as much coal mass at the surface as possible. Viscosity is related to the ability of the polymer fluid to penetrate the surface of the subject media. In particular coal particulates, which have different wetting properties than normal soil or rock particulate, will reject fluid with excessive viscosity while accepting lower viscosity fluid. It is speculated that a hydrophobic mechanism may play a part, possible a result of the hydrocarbon interaction with the coal topper. In addition, the coal topper formulation must not inhibit the ability to unload or burn the coal. A coal topper should not excessively corrode the transport equipment such as the railcars or loading/unloading equipment.

The dust control formulations of the present invention serve all of the above advantages. Embodiments of the present disclosure provide a dust control additive (“DCA”) comprising colloidally-protected, wax-based (“CPWB”) microstructures in an emulsion form. In another embodiment, the present invention relates to the process of preparing such dust control additive emulsions. Dust control additive refers to any ingredient capable of preventing, minimizing, suppressing, reducing, or inhibiting the formation of particles capable of becoming airborne. The expressions “airborne particles” or “airborne dust particles” refer to fine particles generated during the many industrial and/or other process operations such as dumping of material, transportation, transfer point operation, stockpiling, storage, reclaiming, conveyoring, shearing, continuous mining, crushing, screening and sifting, drying, packaging, filling, sanding and abrading While the disclosure infra describes the DCA of the present invention in the context of coal topping, the DCA emulsion can also be used with other particulate materials where airborne particles are generated.

The present invention also relates to dust control formulations comprising the dust control additive and methods for preparing such dust control formulations. By “dust control formulation” (DCF) is meant a formulation such as a spray comprising DCA emulsion which helps in control of airborne particles. According to the present invention, there are provided dust control formulations suitable for spraying and applying to particulate materials requiring dust control. The compositions of the present invention include a dust control additive combined with other ingredients to form an aqueous system, or a non-aqueous system including fillers, binders, and/or thickeners to form a DCF.

In addition to providing a dust control property, the DCF of the present invention may also be hydrophobic, and thus, water-resistant. Further, the embodiments of the present invention also provide adhesive properties to particulate material to which it is added.

The DCF may be used to create a low-dust, water resistant barrier over the materials on which it is sprayed thereby reducing the dust generated during process and preventing moisture from passing through the material. In one embodiment, the DCF comprises the dust control additive that comprises an activated montan and polyvinyl alcohol-stabilized wax emulsion described further below. By doing so, the resulting dried DCF coated surface can exhibit a low-dust environment and high contact angle, which can lead to exceptional water repellency. Further, the disclosed DCF formed from a wax emulsion can assist with adhesion.

The DCF can be used on various materials such as ground limestone (10 to 1000 μm); fly ash (10 to 200 μm); coal dust (1 to 100 μm); cement dust (3 to 100 μm); carbon black (0.01 to 0.3 μm); and pulverized coal (3 to 500 μm).

In accordance with a characterizing feature of the present invention, the DCF comprises the DCA emulsion which minimizes the quantity of airborne particles generated, for example, during operation of industrial processes. The DCA generally comprises less than 20% of the DCF wet weight. More preferably, the dust control additive comprises between about 0.1% and about 10% of the dust control formulation by wet weight percent and, most preferably, between about 1.5% and about 6%. In one embodiment, the DCA is selected from any one of the following weight percentages:

0.1, 1, 2, 3, 4, 5, 6, 7, 8, 9, 10, 11, 12, 13, 14, 15, 16, 17, 18, 19, and 20.

The weight percentage of DCA emulsion in the DCF can be any number within the range defined by any two numbers above, including the endpoints.

In one embodiment, the DCA emulsion is in the range of from about 0.01 to 1% by weight of the DCF. Stated another way, the DCA emulsion is selected from any one of the following percentages:

0.01, 0.02, 0.03, . . . 0.09, 0.1, 0.11, 0.12, . . . , 0.97, 0.98, 0.99, 1.00. The weight percentage of DCA emulsion in the DCF can be any number within the range defined by any two numbers above, including the endpoints. The dust control additive of the present invention is described in detail infra.

Many ingredients have been found to effectively reduce the quantity of airborne particles generated, including oils such as animal, vegetable, and mineral oils (saturated and unsaturated), and oils derived from petroleum, pitch, natural and synthetic waxes, paraffins, solvents which evaporate slower than water, terpenes, glycols, surfactants, and mixtures thereof. However, the CPWB microstructure based DCA emulsion of the present invention unlocks the synergistic effect of the three desired properties in the DCF, namely, dust control property, water resistance, and adhesion. Dust control additive may cause the dust particles to agglomerate or stick together, thereby forming large heavy particles which tend not to become or remain airborne.

Dust Control Additive

### DEFINITIONS

For the purposes of this invention, a “colloidal dispersion” is a dispersion of a discontinuous phase in a continuous phase, comprising colloidally-protected wax-based microstructures.

By “wax” is meant any naturally occurring or synthetically occurring wax. It also includes blends or mixtures of one or more naturally occurring and/or synthetically occurring waxes. Those of animal origin typically consist of wax esters derived from a variety of carboxylic acids and fatty alcohols. The composition depends not only on species, but also on geographic location of the organism. Because they are mixtures, naturally produced waxes are softer and melt at lower temperatures than the pure components. Waxes are further discussed infra.

By “emulsion” or “wax-based emulsion” is meant an aqueous colloidally occurring dispersion or mixture in a liquid or paste-like form comprising wax materials, which has both the discontinuous and the continuous phases, preferably as liquid. For example, an aqueous wax system can either be a general colloid, or it can be an emulsion (which is a type of colloid), depending on the melt temperature of the emulsified wax versus the use temperature. In the disclosure below, the term “emulsion” is used. It should be noted, however, that a colloidal dispersion is also within the scope of the present invention.

By “colloidally-protected wax-based microstructure” (CPWB microstructure) is meant a colloidal dispersion or emulsion, wherein the microstructure is colloidally protected with a wax or a lower fraction hydrocarbon core. The microstructure can exist in a dispersion or emulsion form.

Colloidally-Protected Wax-Based Microstructures

This invention relates to DCA materials that comprise CPWB microstructures, preferably in an emulsion form. They have been alternatively called “CPWB microstructure based DCA emulsion,” or “DCA emulsion,” or “DCA emulsion comprising CPWB microstructure.” CPWB microstructures have a wax core and film or casing of polymeric moieties which are adhered to the core via secondary forces such as Van Der Waals forces as opposed to a mechanical shell over a core in a classical core-shell structure. CPWB microstructures are described in detail below. In the aqueous emulsion of the DCA comprising the CPWB microstructures, the core may be fully or partially encapsulated, in that the colloidal shell is not a physical shell like that of a typical core-shell structure. The DCA emulsion comprising CPWB microstructure provides low-dust property, adhesion property and water resistance property to the material to which it is added.

CPWB Microstructure Shell

The polymers selected for the shell of the CPWB microstructures for low-dust joint compound applications are one or more of the following:

Polyvinyl alcohol and copolymers, cellulose ethers, polyethylene oxide, polyethyleneimines, polyvinylpyrrolidone, and copolymers, polyethylene glycol, polyacrylamides and poly (N-isopropylamides, pullulan, sodium alginate, gelatin, and starches. Polyvinyl alcohol and copolymers are preferred.

CPWB Microstructure Core

The core of the colloidally-protected wax-based microstructures can be a paraffin wax that is a linear alkane with a general formula of CₙH₂ₙ₊₂, wherein n varies from 13 to 80. The paraffin wax defined by n=13 is called tridecane and the one with n=80 is octacontane. The melting point of C₁₃ wax is −5.4° C. Similarly, the melting point of the C₆₀ wax is 100° C. Similarly, the melting point of higher waxes (between C₆₀ and C₈₀) is higher than 100° C. but lower than the melting point of the colloidally-protective polymeric shell.

Some embodiments of the present invention envision wax that comprises branched structures as well as a blend or mixture of linear and branched structures of the wax. This invention also embodies mixtures or blends of waxes with two or more carbon numbers that may either be linear, branched, or blends of linear and branched structures. For example, a wax could be a mixture of C₁₅ linear and C₂₀ linear hydrocarbon alkane wax. In another example, the wax could be a mixture of C₁₆ linear and C₁₆ branched hydrocarbon alkane wax. In yet another example, the wax could be a mixture of C₁₅ linear, C₁₆ linear, and C₂₀ branched. In yet another example, the wax could be a mixture of C₁₈ linear, C₁₈ branched.

Waxes usable as core in the CPWB microstructure-based DCA emulsion of the present invention are described.

Waxes

For the purposes of the present invention, waxes include naturally occurring waxes and synthetic waxes. Naturally occurring waxes include plant based waxes, animal waxes, and mineral waxes. Synthetic waxes are made by physical or chemical processes.

Examples of plant based waxes include mixtures of unesterified hydrocarbons, which may predominate over esters. The epicuticular waxes of plants are mixtures of substituted long-chain aliphatic hydrocarbons, containing alkanes, alkyl esters, sterol esters, fatty acids, primary and secondary alcohols, diols, ketones, aldehydes, aliphatic aldehydes, primary and secondary alcohols, β-diketones, triacylglycerols, and many more. The nature of the other lipid constituents can vary greatly with the source of the waxy material, but they include hydrocarbons. Specific examples of plant wax include Carnauba wax, which is a hard wax obtained from the Brazilian palm Copemicia prunifera, which contains the ester myricyl cerotate. Other plant based waxes include candelilla wax, ouricury wax, jojoba plant wax, bayberry wax, Japan wax, sunflower wax, tall oil, tallow wax, rice wax, and tallows.

Animal wax includes beeswax as well as waxes secreted by other insects. A major component of the beeswax used in constructing honeycombs is the ester myricyl palmitate which is an ester of triacontanol and palmitic acid. Spermaceti occurs in large amounts in the head oil of the sperm whale. One of its main constituents is cetyl palmitate, another ester of a fatty acid and a fatty alcohol. Lanolin is a wax obtained from wool, consisting of esters of sterols. Other animal wax examples include lanocerin, shellac, and ozokerite.

Examples of mineral waxes include montan wax, paraffin wax, microcrystalline wax and intermediate wax. Although many natural waxes contain esters, paraffin waxes are hydrocarbons, mixtures of alkanes usually in a homologous series of chain lengths. Paraffin waxes are mixtures of saturated n- and iso-alkanes, naphthenes, and alkyl- and naphthene-substituted aromatic compounds. The degree of branching has an important influence on the properties. Montan wax is a fossilized wax extracted from coal and lignite. It is very hard, reflecting the high concentration of saturated fatty acids/esters and alcohols. Montan wax includes chemical components formed of long chain alkyl acids and alkyl esters having chain lengths of about 24 to 30 carbons. In addition, natural montan includes resin acids, polyterpenes and some alcohol, ketone and other hydrocarbons such that it is not a “pure” wax. The saponification number of montan, which is a saponifiable wax, is about 92 and its melting point is about 80° C.

Other waxes include petroleum waxes derived from crude oil after processing, which include macrocrystalline wax, microcrystalline wax, petrolatum and paraffin wax. Paraffin wax is formed principally of straight-chain alkanes having average chain lengths of 20-30 carbon atoms.

Waxes comprising esters and/or acids may act as emulsifiers to the paraffins.

Synthetic waxes include waxes based on polypropylene, polyethylene, and polytetrafluoroethylene. Other synthetic waxes are based on fatty acid amines, Fischer Tropsch, and polyamides, polyethylene and related derivatives. Some waxes are obtained by cracking polyethylene at 400° C. The products have the formula (CH₂)ₙH₂, where n ranges between about 50 and 100.

Also outside of the building products context, in addition to waxes that occur in natural form, there are various known synthetic waxes which include synthetic polyethylene wax of low molecular weight, i.e., molecular weights of less than about 10,000, and polyethylenes that have wax-like properties. Such waxes can be formed by direct polymerization of ethylene under conditions suitable to control molecular weight. Polyethylenes with molecular weights in about the 2,000-4,000 range are waxes, and when in the range of about 4,000-12,000 become wax resins.

Fischer-Tropsch waxes are polymethylene waxes produced by a particular polymerization synthesis, specifically, a Fischer-Tropsch synthesis (polymerization of carbon monoxide under high pressure, high temperature and special catalysts to produce hydrocarbon, followed by distillation to separate the products into liquid fuels and waxes). Such waxes (hydrocarbon waxes of microcrystalline, polyethylene and polymethylene types) can be chemically modified by, e.g., air oxidation (to give an acid number of 30 or less and a saponification number no lower than 25) or modified with maleic anhydride or carboxylic acid. Such modified waxes are more easily emulsified in water and can be saponified or esterified. Other known synthetic waxes are polymerized alpha-olefins. These are waxes formed of higher alpha-olefins of 20 or more carbon atoms that have wax like properties. The materials are very branched with broad molecular weight distributions and melting points ranging about 54° C. to 75° C. with molecular weights of about 2,600 to 2,800. Thus, waxes differ depending on the nature of the base material as well as the polymerization or synthesis process, and resulting chemical structure, including the use and type of any chemical modification.

Various types of alpha-olefin and other olefinic synthetic waxes are known within the broad category of waxes, as are chemically modified waxes, and have been used in a variety of applications, outside the water-resistant wallboard area. They are of a wide variety and vary in content and chemical structure. As noted above, water-resistant wallboard products generally use paraffin, paraffin and montan, or other paraffinic or synthetic waxes as described above in the mentioned exemplary patent references. In one embodiment of the invention, the wax used for the preparation of the dispersion or emulsion is used in a micronized, pulverized form. U.S. Pat. Nos. 8,669,401 and 4,846,887 show exemplary micronization processes. Both these patents are incorporated by reference herein as if fully set forth.

In one embodiment, the emulsifiers for this invention include montan wax, esters/acids, styrene-maleic anhydride, polyolefin maleic anhydride, or other anhydrides, carnauba wax, rice wax, sunflower wax.

Theory for Colloidally-Protected Wax-Based Microstructures

Generally speaking, two scientific theories have been proposed to explain the stability of CPWB microstructures that comprise the DCA emulsion materials of the present invention, namely, steric hindrance and electrostatic repulsion. Applicants do not wish to be bound by these theories, however. Applicants believe their invention relates to wax-based dispersions that may or may not relate to the two theories. It is possible that one or both theories or neither of the two may explain the CPWB microstructures of the present invention.

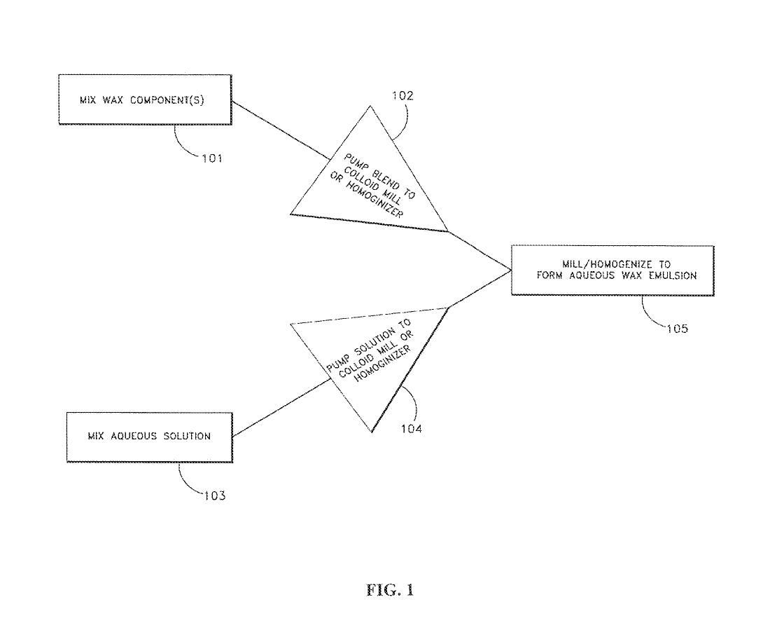

As described in FIG. 1, in the first step, a colloidally-protected wax based microstructures in an emulsion are prepared. The emulsion is prepared according to the specification for their use in variety of applications. For a general understanding of the method of making the exemplary wax emulsion, reference is made to the flow diagram in FIG. 1. As shown in 101, first the wax components may be mixed in an appropriate mixer device. Then, as shown in 102, the wax component mixture may be pumped to a colloid mill or homogenizer. As demonstrated in 103, in a separate step, water, and any emulsifiers, stabilizers, or additives (e.g., ethylene-vinyl alcohol-vinyl acetate terpolymer) are mixed. Then the aqueous solution is pumped into a colloid mill or homogenizer in 104. Steps 101 and 103 may be performed simultaneously, or they may be performed at different times. Steps 102 and 104 may be performed at the same time, so as to ensure proper formation of droplets in the emulsion. In some embodiments, steps 101 and 102 may be performed before step 103 is started. Finally, as shown in 105, the two mixtures from 102 and 104 are milled or homogenized to form an aqueous wax-based emulsion.

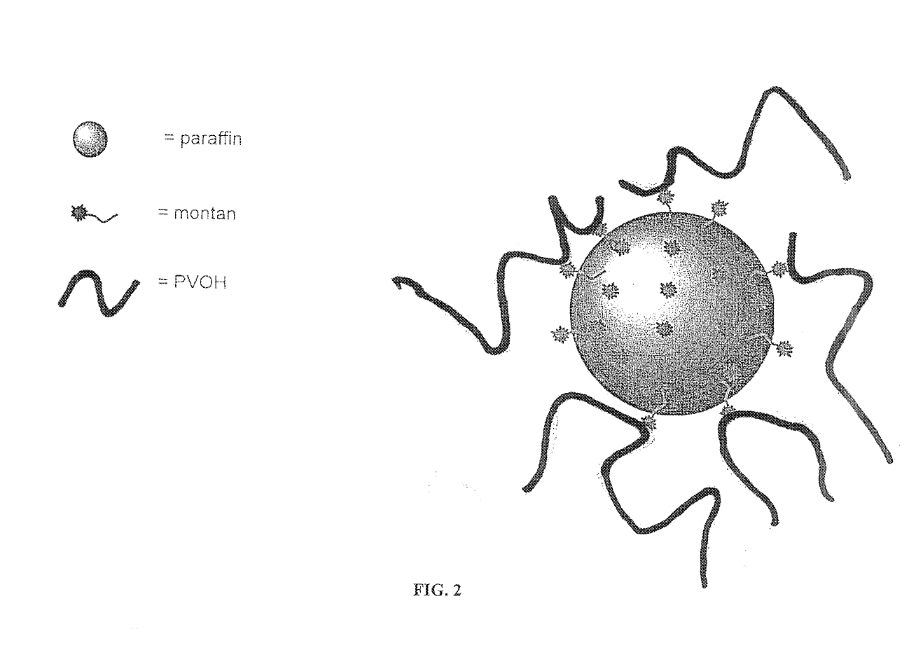

FIG. 2 describes the particle model of a unitary wax particle that has been stabilized in the colloidal dispersion. Applicants do not wish to be bound by the theory of the unitary wax particle stabilized in the dispersion. According to this model, the hydrophobic hydrocarbon “tail” of the montan is embedded in the paraffin particle. The “head” of montan, which is hydrophilic is then tethered to polyvinyl alcohol. The first mechanism by which many of the wax emulsions (colloidal dispersions) are stabilized is the steric hindrance mechanism. According to this mechanism, high molecular weight polymers (e.g. PVOH) are tethered to the outer surface of a wax particle and surround it. Due to steric hindrance, the PVOH molecules surrounding each wax particle then prevent adjacent wax particles from coalescing.

Alternatively, electrostatic repulsion helps with the stabilization of the colloidal dispersions. In this mechanism, the wax particle, which contains acid or ester groups (either inherently or mixed in), is first saponified with a base, converting the acid or ester groups to negatively charged carboxylate moieties. Because of their polar nature, these negatively charged carboxylate moieties exist at the water/wax interface, giving the wax particle a net negative charge. These negative charges on adjacent wax particles then constitute a repulsive force between particles that effectively stabilizes the dispersion (emulsion).

Thus, according to one model, as shown in FIG. 2, a wax particle is enclosed in a “web” of PVOH polymeric chains. This is not akin to a shell of a typical core-shell particle, but the PVOH loosely protects (colloidally protects) the wax particle. One could envision the wax particle as a solid ball or a nucleus surrounded by polymeric chains like strings.

Thus, according to one model, as shown in FIG. 2, a wax particle is enclosed in a “web” of PVOH polymeric chains. This is not akin to a shell of a typical core-shell particle, but the PVOH loosely protects (colloidally protects) the wax particle. One could envision the wax particle as a solid ball or a nucleus surrounded by polymeric chains like strings.

In another embodiment, and as shown in FIGS. 3 and 4, the polymer, for example PVOH, forms a shell like physical film or casing such as a film (PVOH is an excellent film former), the casing herein is based on secondary forces of attraction, e.g., Van der Waals forces. Hydrogen bonding may also be one of the forces for the encapsulation of the PVOH of the wax particles. Applicants do not wish to be bound by this theory. However, the model does explain the wax particle with the PVOH casing over it. In the above examples, PVOH is used as an exemplary polymeric system. However, other polymeric systems used herein, or their combinations can also be used to prepare the colloidally-protected wax-based microstructures.

Dust Control Additive Emulsion

Exemplary emulsion comprising CPWB microstructure for use in, for example, as a dust reduction additive (and for water-resistance) in a joint compound are now described in greater detail, as follows.

In one embodiment, the wax emulsion may comprise water, a base, one or more waxes optionally selected from the group consisting of slack wax, montan wax, and paraffin wax, and a polymeric stabilizer, such as ethylene-vinyl alcohol-vinyl acetate terpolymer or polyvinyl alcohol. Further, carnauba wax, sunflower wax, tall oil, tallow wax, rice wax, and any other natural or synthetic wax or emulsifier containing organic acids and/or esters can be used to form the wax emulsion.

Water may be provided to the emulsion, for example in amounts of about 30% to about 60% by weight of the emulsion. The solids content of the wax emulsion is preferably about 40% to about 70% by weight of the emulsion. Other amounts may be used.

In some embodiments, a dispersant and/or a surfactant may be employed in the wax emulsions. Optional dispersants, include, but are not limited to those having a sulfur or a sulfur-containing group(s) in the compound such as sulfonic acids (R—S(═O)₂—OH) and their salts, wherein the R groups may be otherwise functionalized with hydroxyl, carboxyl or other useful bonding groups. In some embodiments, higher molecular weight sulfonic acid compounds such as lignosulfonate, lignosulfonic acid, naphthalene sulfonic acid, the sulfonate salts of these acids, and derivatized or functionalized versions of these materials are used in addition or instead. An example lignosulfonic acid salt is Polyfon® H available from MeadWestvaco Corporation, Charleston, S.C. Other dispersants may be used, such as magnesium sulfate, polycarboxylate technology, ammonium hepta molybdate/starch combinations, non-ionic surfactants, ionic surfactants, zwitterionic surfactants and mixtures thereof, alkyl quaternary ammonium montmorillonite clay, etc. Similar materials may also be used, where such materials may be compatible with and perform well with the formulation components.

In one embodiment, a dispersant and/or surfactant may comprise about 0.01% to about 5.0% by weight of the wax emulsion formulation composition, preferably about 0.1% to about 2.0% by weight of the wax emulsion formulation composition. Other concentrations may be used.

The wax component of the emulsion may include at least one wax which may be slack wax, or a combination of montan wax and slack wax. The total wax content may be about 30% to about 60%, more preferably about 30% to about 40% by weight of the emulsion. Slack wax may be any suitable slack wax known or to be developed which incorporates a material that is a higher petroleum refining fraction of generally up to about 20% by weight oil. In addition to, or as an alternative to slack wax, paraffin waxes of a more refined fraction are also useful within the scope of the invention.

Suitable paraffin waxes may be any suitable paraffin wax, and preferably paraffins of melting points of from about 40° C. to about 110° C., although lower or higher melting points may be used if drying conditions are altered accordingly using any techniques known or yet to be developed in the composite board manufacturing arts or otherwise. Thus, petroleum fraction waxes, either paraffin or microcrystalline, and which may be either in the form of varying levels of refined paraffins, or less refined slack wax may be used. Optionally, synthetic waxes such as ethylenic polymers or hydrocarbon types derived via Fischer-Tropsch synthesis may be included in addition or instead, however paraffins or slack waxes are preferred in certain embodiments. The wax emulsion used in the joint compound can be formed from slack wax, montan wax, paraffin wax, carnauba wax, tall oil, sunflower wax, rice wax, and any other natural or synthetic wax containing organic acids and/or esters, or combinations thereof. For example, synthetic wax used in the joint compound may comprise ethylenic polymers or hydrocarbon types, optionally derived via Fischer-Tropsch synthesis, or combinations thereof. Optionally, the synthetic waxes can be added in concentrations ranging from about 0.1% to about 8% of the dry weight of the joint compound or from about 0.5% to about 4.0% of the dry weight of the joint compound. In some embodiments, the wax emulsion is stabilized by polyvinyl alcohol.

Montan wax, which is also known in the art as lignite wax, is a hard, naturally occurring wax that is typically dark to amber in color (although lighter, more refined montan waxes are also commercially available). Montan is insoluble in water, but is soluble in solvents such as carbon tetrachloride, benzene and chloroform. In addition to naturally derived montan wax, alkyl acids and/or alkyl esters which are derived from high molecular weight fatty acids of synthetic or natural sources with chain lengths preferably of over 18 carbons, more preferably from 26 to 46 carbons that function in a manner similar to naturally derived montan wax are also within the scope of the invention and are included within the scope of “montan wax” as that term is used herein unless the context indicates otherwise (e.g., “naturally occurring montan wax”). Such alkyl acids are generally described as being of formula R—COOH, where R is an alkyl non-polar group which is lipophilic and can be from 18 to more than 200 carbons. An example of such a material is octacosanoic acid and its corresponding ester which is, for example, a di-ester of that acid with ethylene glycol. The COOH group forms hydrophilic polar salts in the presence of alkali metals such as sodium or potassium in the emulsion. While the alkyl portion of the molecule gets embedded within the paraffin, the acid portion is at the paraffin/aqueous medium interface, providing stability to the emulsion.

In some embodiments, the at least one wax component of the emulsion includes primarily and, preferably completely a slack wax component. In some embodiments, the at least one wax component is made up of a combination of paraffin wax and montan wax or of slack wax and montan wax. Although it should be understood that varying combinations of such waxes can be used. When using montan wax in combination with one or more of the other suitable wax components, it is preferred that montan be present in an amount of about 0.1% to about 10%, more preferably about 1% to about 4% by weight of the wax emulsion with the remaining wax or waxes present in amounts of from about 30% to about 50%, more preferably about 30% to about 35% by weight of the wax emulsion.

In some embodiments, the wax emulsion includes polyvinyl alcohol (PVOH) of any suitable grade which is at least partially hydrolyzed. The preferred polyvinyl alcohol is at least 50%, and more preferably at least 90%, and most preferably about 97-100% hydrolyzed polyvinyl acetate. The PVA can be hydrolyzed to the extent defined by the percentage numbers below:

50, 55, 60, 65, 70, 75, 80, 85, 90, 95, and 100.

The PVA can also be hydrolyzed up to the extent of a number that resides in the range defined by any two numbers above, including the endpoints.

Suitably, the polyvinyl alcohol is soluble in water at elevated temperatures of about 60° C. to about 95° C., but insoluble in cold water. The hydrolyzed polyvinyl alcohol is preferably included in the emulsion in an amount of up to about 5% by weight, preferably 0.1% to about 5% by weight of the emulsion, and most preferably about 2% to about 3% by weight of the wax emulsion.

In some embodiments, the stabilizer comprises a polymer that is capable of hydrogen bonding to the carboxylate or similar moieties at the water/paraffin interface. Polymers that fit the hydrogen-bonding requirement would have such groups as hydroxyl, amine, and/or thiol, amongst others, along the polymer chain. Reducing the polymer's affinity for water (and thus, its water solubility) could be achieved by inserting hydrophobic groups such as alkyl, alkoxy silanes, or alkyl halide groups into the polymer chain. The result may be a polymer such as ethylene-vinyl acetate-vinyl alcohol terpolymer (where the vinyl acetate has been substantially hydrolyzed). The vinyl acetate content may be between 0% to 15%. In some embodiments, the vinyl acetate content is between 0% and 3% of the terpolymer chain. The ethylene-vinyl alcohol-vinyl acetate terpolymer may be included in the emulsion in an amount of up to about 10.0% by weight, preferably 0.1% to about 5.0% by weight of the emulsion. In some embodiments, ethylene-vinyl alcohol-vinyl acetate terpolymer may be included in the emulsion in an amount of about 2% to about 3% by weight of the wax emulsion. An example ethylene-vinyl alcohol-vinyl acetate terpolymer that is available is the Exceval AQ4104™, available from Kuraray Chemical Company.

The dust reduction additive wax emulsion may include a stabilizer material (e.g., PVOH, ethylene-vinyl alcohol-vinyl acetate terpolymer as described above). The stabilizer may be soluble in water at elevated temperatures similar to those disclosed with reference to PVOH (e.g., about 60° C. up to about 95° C.), but insoluble in cold water. The active species in the wax component (e.g., montan wax) may be the carboxylic acids and esters, which may comprise as much as 90% of the wax. These chemical groups may be converted into carboxylate moieties upon hydrolysis in a high pH environment (e.g., in an environment including aqueous KOH). The carboxylate moieties may act as a hydrophilic portion or “head” of the molecule. The hydrophilic portions can directly interface with the surrounding aqueous environment, while the rest of the molecule, which may be a lipophilic portion or “tail”, may be embedded in the hydrocarbon wax.

A stabilizer capable of hydrogen bonding to carboxylate moieties (e.g., PVOH or ethylene-vinyl alcohol-vinyl acetate terpolymer as described above) may be used in the wax emulsion. The polar nature of the carboxylate moiety may offer an optimal anchoring point for a stabilizer chain through hydrogen bonding. When stabilizer chains are firmly anchored to the carboxylate moieties as described above, the stabilizer may provide emulsion stabilization through steric hindrance. In embodiments where the wax emulsion is subsequently dispersed in a wallboard (e.g., gypsum board) system, all the water may be evaporated away during wallboard manufacture. The stabilizer may then function as a gate-keeper for repelling moisture. Decreasing the solubility of the stabilizer in water may improve the moisture resistance of the wax emulsion and the wallboard. For example, fully hydrolyzed PVOH may only dissolve in heated, and not cool, water. For another example, ethylene-vinyl alcohol-vinyl acetate terpolymer may be even less water soluble than PVOH. The ethylene repeating units may reduce the overall water solubility. Other stabilizer materials are also possible. For example, polymers with hydrogen bonding capability such as those containing specific functional groups, such as alcohols, amines, and thiols, may also be used. For another example, vinyl alcohol-vinyl acetate-silyl ether terpolymer can be used. An example vinyl alcohol-vinyl acetate-silyl ether terpolymer is Exceval R-2015, available from Kuraray Chemical Company. In some embodiments, combinations of stabilizers are used.

In some embodiments, the wax emulsion comprises a base. For example, the wax emulsion may comprise an alkali metal hydroxide, such as potassium hydroxide or other suitable metallic hydroxide, such as aluminum, barium, calcium, lithium, magnesium, sodium and/or zinc hydroxide. These materials may serve as saponifying agents. Non-metallic bases such as derivatives of ammonia as well as amines (e.g., diethanolamine or triethanolamine) can also be used. Combinations of the above-mentioned materials are also possible. If included in the wax emulsion, potassium hydroxide is preferably present in an amount of 0% to 1%, more preferably about 0.1% to about 0.5% by weight of the wax emulsion.

In some embodiments, an exemplary wax emulsion comprises: about 30% to about 60% by weight of water; about 0.1% to about 5% by weight of a lignosulfonic acid or a salt thereof; about 0% to about 1% by weight of potassium hydroxide; about 30% to about 50% by weight of wax selected from the group consisting of paraffin wax, slack wax and combinations thereof; and about 0.1% to about 10% montan wax, and about 0.1 to 5% by weight of ethylene-vinyl alcohol-vinyl acetate terpolymer.

The wax emulsion may further include other additives, including without limitation additional emulsifiers and stabilizers typically used in wax emulsions, flame retardants, lignocellulosic preserving agents, fungicides, insecticides, biocides, waxes, sizing agents, fillers, binders, additional adhesives and/or catalysts. Such additives are preferably present in minor amounts and are provided in amounts which will not materially affect the resulting composite board properties. Preferably no more than 30% by weight, more preferably no more than 10%, and most preferably no more than 5% by weight of such additives are present in the wax emulsion.

Shown in the below tables are exemplary embodiments of a wax emulsion, although other quantities in weight percent may be used.

TABLE 1
First Exemplary Embodiment of Dust Reduction Additive Emulsion

| Raw Material | Quantity in Weight Percent |
|---|---|
| Water | 58 |
| Polyvinyl Alcohol | 2.70 |
| Dispersant (Optional) | 1.50 |
| Paraffin Wax | 34.30 |
| Montan Wax | 3.50 |
| Biocide | 0.02 |

TABLE 2
Second Exemplary embodiment of Dust Reduction Additive Emulsion

| Raw Material | Quantity in Weight Percent |
|---|---|
| Water | 58.80 |
| Polyvinyl Alcohol | 2.80 |
| Diethanol Amine | 0.04 |
| Paraffin Wax | 34.80 |
| Montan Wax | 3.50 |
| Biocide | 0.10 |

The wax emulsion may be prepared using any acceptable techniques known in the art or to be developed for formulating wax emulsions, for example, the wax(es) are preferably heated to a molten state and blended together (if blending is required). A hot aqueous solution is prepared which includes any additives such as emulsifiers, stabilizers, etc., ethylene-vinyl alcohol-vinyl acetate terpolymer (if present), potassium hydroxide (if present) and lignosulfonic acid or any salt thereof. The wax is then metered together with the aqueous solution in appropriate proportions through a colloid mill or similar apparatus to form a wax emulsion, which may then be cooled to ambient conditions if desired.

In some embodiments, the wax emulsion may be incorporated with or coated on various surfaces and substrates. For example, the wax emulsion may be mixed with gypsum to form a gypsum wallboard having improved moisture resistance properties.

Some or all steps of the above method may be performed in open vessels. However, the homogenizer may use pressure in its application.

Advantageously in some embodiments, the emulsion, once formed, is cooled quickly. By cooling the emulsion quickly, agglomeration and coalescence of the wax particles may be avoided.

In some embodiments the wax mixture and the aqueous solution are combined in a pre-mix tank before they are pumped into the colloid mill or homogenizer. In other embodiments, the wax mixture and the aqueous solution may be combined for the first time in the colloid mill or homogenizer. When the wax mixture and the aqueous solution are combined in the colloid mill or homogenizer without first being combined in a pre-mix tank, the two mixtures may advantageously be combined under equivalent or nearly equivalent pressure or flow rate to ensure sufficient mixing.

In some embodiments, once melted, the wax emulsion is quickly combined with the aqueous solution. While not wishing to be bound by any theory, this expedited combination may beneficially prevent oxidation of the wax mixture.

Dust Control Formulation

Embodiments of the disclosed CPWB microstructure based dust control additive emulsion can be used to form a dust control formulation (DCF). The DCF can be used to top coal carrying railcars. It can also be used in various industrial operations to control the dust formation, for example, in all coal processes such as size reduction.

In one embodiment, an appropriately prepared formulation is sprayed over the coal, which penetrates the materials and binds the particles that could otherwise be airborne. The DCF can also be specially formulated to serve as a cover coat on in storage facilities such as silos and bins and other containers. The DCF can be particularly useful in locations where there is high humidity.

The DCF comprises a filler material. Any conventional filler material can be used in the present invention. Suitable fillers include calcium carbonate (CaCO₃) and calcium sulfate dihydrate (CaSO₄ 2H₂O commonly referred to as gypsum) for ready mixed type DCFs, and calcium sulfate hemihydrates (CaSO₄-½ H₂O) for setting type DCFs. The DCF can also include one or more secondary fillers such as glass micro bubbles, mica, perlite, talc, limestone, pyrophyllite, silica, and diatomaceous earth. The filler generally comprises from about 1% to about 95% of the weight of the DCF based on the total wet weight of the formulation (i.e. including water). Another ingredient usually present in DCF is a binder or resin. Suitable binders include polyvinyl acetate, polyvinyl alcohol, ethylene vinyl acetate co-polymer, vinylacrylic co-polymer, styrenebutadiene, polyacrylamide, other acrylic polymers, other latex emulsions, natural and synthetic starch, and casein. These binders can be used alone or in combination with one another. The amount of binder can range from about 1% to about 45% of the DCF total wet weight. More preferably, the binder comprises from about 1% to about 20% of the total wet weight, and most preferably, from about 4% to about 14%.

A surfactant can also be included in the DCF formulation. The surfactant generally comprises less than about 3.5% of the DCF total wet weight, and preferably less than about 0.25%.

Many DCF formulations also contain a cellulosic thickener, usually a cellulosic ether. Suitable thickeners include methyl cellulose, hydroxypropyl cellulose, hydroxypropyl methyl cellulose, hydroxyethyl cellulose, hydroxyethyl methyl cellulose, hydroxyethyl hydroxypropyl cellulose, ethylhydroxyethyl cellulose, and sodium carboxymethyl cellulose (CMC). These thickeners can be used alone or in combination with one another. The amount of cellulosic thickener can range from about 0.1% to about 2% by weight of the DCF. A preferred thickener is hydroxypropyl methyl cellulose available from Dow Chemical Company under the trade designation Methocel.

Another ingredient that can be included in the DCF of the invention is a non-leveling agent. Suitable non-leveling agents include clays such as attapulgus clay, bentonite, illite, kaolin and sepiolite, and clays mixed with starches. Thickeners, such as those described above, can also function as non-leveling agents.

Additional ingredients which can be utilized in the DCF are preservatives, fungicides, anti-freeze wetting agents, defoamers, flocculants, such as polyacrylamide resin, and plasticizers, such as dipropylene glycol dibenzoate.

The wax emulsion used in the DCF can be formed from slack wax, montan wax, paraffin wax, carnauba wax, tall oil, sunflower wax, rice wax, and any other natural or synthetic wax containing organic acids and/or esters, or combinations thereof. For example, synthetic wax used in the DCF may comprise ethylenic polymers or hydrocarbon types, optionally derived via Fischer-Tropsch synthesis, or combinations thereof. By way of further example, synthetic wax used in the DCF may comprise polyethylene glycol, methoxypolyethylene glycol, or combinations thereof. Optionally, the synthetic waxes can be added in concentrations ranging from about 0.1% to about 8% of the dry weight of the DCF or from about 0.5% to about 4.0% of the dry weight of the DCF. In some embodiments, the wax emulsion is stabilized by polyvinyl alcohol.

In some embodiments, perlite can be used in a DCF to, for example, control the density, shrinkage, and crack resistance of the DCF. In some embodiments, perlite need not be used (e.g., where weight is not as much of a factor).

In some embodiments, clay can be used in a DCF as, for example, a non-leveling agent and/or a thickening agent that can control the viscosity or rheology of the final product. Clay can also help enhance or create the water-holding properties of the DCF.

In some embodiments, thickeners can be used to control the viscosity, affect the rheology, and affect the water holding characteristics of a DCF. For example, cellulose ether can be used as a thickener.

In some embodiments, binders can be used in a DCF to, for example, improve bonding to the substrate such as coal.

In some embodiments, a glycol can be used in a DCF to provide functional such as wet edge, open time, controlling drying time, and freeze/thaw stability.

In some embodiments, other rheology modifiers can also be used in conjunction with, or instead of, some of the above described compositions.

In some embodiments, fillers can be used in the DCF although a lower viscosity closer to that of water (for spraying purposes) is preferred. For example, calcium carbonate, calcium sulfate hemihydrates, or calcium sulfate dehydrated can all be used as fillers, though other materials can be used as well. Further, thickeners, preservatives, binders, and other additives can be incorporated into the DCF.

Other additives can also be added to the described DCF in addition to the wax emulsion. In some embodiments, metal siliconate salts such as, for example, potassium siliconate, as well as silicone based compounds such as, for example, poly hydrogen methyl siloxane and polydimethyl siloxane, could provide advantageous water resistance to a DCF. In some embodiments, fluorinated compounds and stearate-based salts could also be used to provide advantageous water resistance.

Wax emulsions can be particularly advantageous for use in a DCF as compared to, for example, non-emulsified and/or non-stabilized waxes such as melted PEG M750. These non-emulsified waxes can impart severe deleterious effects on the adhesion properties of a DCF. Therefore, if the non-emulsified wax is to be used at all, it must be added in very low levels. On the other hand, wax emulsions, such as those described herein, can advantageously increase the adhesion properties of a DCF, at least due to the adhesive effects of the stabilizer, and thus can be added at higher dosage levels. The wax emulsions can then be useful as they can provide both dust control properties as well as water repellency to the DCF and the substrate on which it is sprayed. The wax emulsion can soften or melt when friction is applied, such as during transportation and handling. Accordingly, dust can be agglomerated by the softened wax emulsion, where it can be securely held.

Embodiments of the DCF can be applied in thin layers to a surface. The DCF can be applied by, for example, using a spraying device. However, the application and thickness of the layers of DCF is not limiting. Further, multiple layers may be applied in order to obtain an appropriate dust control. The number or layers applied is not limiting. In some embodiments, each layer can be allowed to dry prior to application of the next layer. In some embodiments, a second layer can be applied when the first layer is only partially dried.

In some embodiments, the DCF can be aqueous. In addition to a latex binder, other water soluble binders, such as polyvinyl alcohol, can be used as well. Other materials, such as talc, binders, fillers, thickening agents, preservatives, limestone, perlite, urea, defoaming agents, gypsum latex, glycol, and humectants can be incorporated into the DCF as well or can substitute for certain ingredients (e.g., talc can be used in place of, or in addition to mica; gypsum can be used in place of, or in addition to calcium carbonate, etc.). In some embodiments, the calcium carbonate can be replaced either wholly or partially with a surface micro-roughened filler that can further enhance the DCF's hydrophobicity. In some embodiments, Calcimatt™, manufactured by Omya AG, can be used. In some embodiments, cristobalite (silicon dioxide) such as Sibelite® M3000, manufactured by Quarzwekre, can be used. These fillers can be used alone or in combination.

In some embodiments, the DCF is aqueous and can be applied to the substrate and can be allowed to dry. Once the water evaporates from the mixture, a dry, relatively hard cementitious material can remain. An example formula range of an embodiment of a water-resistant DCF using the above disclosed wax is shown in the below Table 3:

TABLE 3
Exemplary Composition of a DCF

| Component | Percent Range |
|---|---|
| Water | 20-55% |
| Preservatives | 0.02-1.0% |
| Calcium Carbonate | 10-50% |
| Mica | 0.5-10% |
| Attapulgite Clay | 0.2-10% |
| Talc | 0.0-10% |
| Perlite | 0.0-40% |
| Polyethylene Oxide | 0.0-10% |
| Polyether Siloxane | 0.0-10% |
| Wax Emulsion | 0.1-20% |
| Latex Binder | 0.5-10% |
| Cellulose Ether Thickener | 0.1-8.0% |

Further, an example of a specific formulation for a low-dust/water-resistant DCF can is shown in the below Table 4, although other weight percentages may be used:

TABLE 4
Example Composition of a Low-Dust Joint Compound

| Compound | Wt. % |
|---|---|
| Preservative | 0.01 |
| Wetting Agent | 0.05 |
| Latex Binder | 5.89 |
| Water | 34.60 |
| Wax Emulsion | 7.36 |
| Cellulose Ether | 0.55 |
| Attapulgite Clay | 1.84 |
| Mica | 7.36 |
| Calcium Carbonate | 33.86 |
| Expanded Perlite | 8.47 |

Another embodiment of a low-dust/water-resistant ready-mix DCF formula is shown in the below Table 5. In this embodiment, an optional potassium siliconate additive is incorporated.

TABLE 5
Embodiment of DCF Composition

| Raw Material | Wt. % |
|---|---|
| Preservative | 0.20% |
| Latex (CPS 716) | 6.50% |
| Water | 36.70% |
| Wax Emulsion | 3.80% |
| Potassium Siliconate | 0.20% |
| (Silres BS 16) | |
| Cellulose Ether | 0.60% |
| Clay (Attagel 30) | 1.90% |
| Mica | 6.10% |
| Limestone (MW 100) | 35.20% |
| SilCel 43-34 | 8.80% |

The DCA emulsion formulation is comprised of a paraffin, an emulsifier, usually a carboxylic acid or ester that can be saponified via a reaction with a base, and a stabilizer polyvinyl alcohol. Suitable emulsifiers were montan wax, rice wax, carnauba wax, and any such wax that is composed of a mixture of acids and esters. Standalone acids from C5 to C100, such as stearic acid, can also be used in place of the aforementioned natural waxes. Likewise, standalone esters of similar carbon atom chain length can also be used.

Suitable bases include any compound that is capable of saponifying the ester carboxylate group, or deprotonating the carboxylic acid proton. Suitable bases are inorganic basis such as potassium hydroxide and ammonium hydroxide. Likewise, suitable organic basis are monoethanol amine, diethanol amine, ad triethanol amine.

When the inventive CPWB microstructure based emulsion is used as a dust control additive to the DCF, the DCF improves its dust reduction capability, over and above the simultaneous improvement in water resistance and adhesion. The DCF's ability to reduce dust is measured as peak airborne dust production in mg/m3 units, and for the inventive DCF of the present invention comprising the CPWB microstructure emulsion, the PAD number is reduced by the following percentage numbers, depending upon the content of the CPWB microstructure-based dust control additive emulsion in the DCF10, 15, 20, 25, 30, 35, 40, 45, 50, 55, 60, 75, 80, 85%, 90% and 95%, and 98%. In some embodiments of the present invention the PAD number is reduced by a percentage residing in between a range defined by any two numbers above, including the endpoints of such range.

The wax emulsion was made by heating the emulsifier and the paraffin in a vessel such that both become molten. In a separate vessel, a measured quantity of polyvinyl alcohol was mixed with water at room temperature after which the mixture was heated to about 180 F. The molten paraffin/montan mixture was then combined with the hot water/polyvinyl alcohol mixture which, upon passing through a charlotte mill, emerged as a stable wax emulsion where the polyvinyl alcohol was tethered to the paraffin surface, largely encapsulating the paraffin. A representative formula of the wax emulsion is shown in Table 6.

TABLE 6
Representative Formula of CPWB Microstructure
Based Inventive Wax Emulsion

| Ingredient | Content % |
|---|---|
| Water | 60.3 |
| Polyvinyl alcohol | 3 |
| Paraffin wax | 33.5 |
| Montan wax | 3 |
| Monoethanol amine | 0.2 |
| Total Wt. | 100 |
| % Polyvinyl alcohol | 3.0% |
| % Paraffin | 33.5% |

DCF with Inventive CPWB Microstructure-Based DCA Emulsion

TABLE 7
DCF Formulations

| Experiment | | | | | |
|---|---|---|---|---|---|
| No. [symbol] | Control | 1 | 2 | 3 | 4 |
| | 0% CPWB | 2% CPWB | 3.1% CPWB | 4.7% CPWB | 6.2% CPWB |
| Ingredient | microstructure | microstructure | microstructure | microstructure | microstructure |
| [symbol] | DCA emulsion | DCA emulsion | DCA emulsion | DCA emulsion | DCA emulsion |
| Preservatives | 0.2 | 0.2 | 0.2 | 0.2 | 0.2 |
| Polyether | 0.1 | 0.1 | 0.1 | 0.1 | 0.1 |
| siloxane | | | | | |
| copolymer | | | | | |
| Latex CPS | 7.5 | 5.2 | 5.1 | 4.3 | 3.5 |
| 716 | | | | | |
| Water | 37.9 | 38.1 | 37.6 | 37.3 | 37.0 |
| Wax | 0.0 | 2.0 | 3.1 | 4.7 | 6.2 |
| emulsion | | | | | |
| Cellulose | 0.6 | 0.6 | 0.6 | 0.6 | 0.6 |
| ether | | | | | |
| Attagel 30 | 2.0 | 2.0 | 2.0 | 1.9 | 1.9 |
| clay | | | | | |
| Mica 4K | 6.3 | 6.3 | 6.3 | 6.2 | 6.2 |
| Microwhite | 36.3 | 36.5 | 36.1 | 35.8 | 35.5 |
| 100 calcium | | | | | |
| carbonate | | | | | |
| Perlite, | 9.1 | 9.1 | 9.0 | 8.9 | 8.9 |
| SilCel 43-34 | | | | | |

Five wax emulsions including one Control emulsion were prepared. The Control emulsion had 0% inventive emulsion comprising CPWB microstructures. Experiment 1 had 2%; Experiment 2 had 3.1%; Experiment 3 had 4.7%; and Experiment 4 had 6.2% wax emulsion included in the DCF.

The CPWB microstructure based DCA emulsion that was created in the manner described in this work is comprised of a paraffin particle that is surrounded by polyvinyl alcohol polymer chains that are chemically bound (via hydrogen bonding) to the surface of the paraffin. The paraffin is therefore largely encapsulated by polyvinyl alcohol. Stated differently, there is no substantially exposed paraffin surface in this wax emulsion. The net effect of this is that, when added as a component of a DCF formulation, this wax emulsion augments the low-dust character, water-resistance, as well as adhesion and therefore necessitates the reduction in the formulation's overall binder content. On the other hand a wax emulsion that had been prepared using similar components, but which did not include any polyvinyl alcohol as an emulsion stabilizer during the emulsion preparation stage would have had its paraffin particles exposed. When added as a component of a DCF, this exposed paraffin surface had a deleterious consequence on DCF adhesion, even if polyvinyl alcohol was post-added as part of the DCF formulation. As an example, a wax emulsion was made with no polyvinyl alcohol as shown in Table 8.

TABLE 8
Wax Emulsion with No Polyvinyl Alcohol Encapsulant

| Ingredient | Qty. |
|---|---|
| Water | 61.9 |
| Polyvinyl Alcohol | 0.0 |
| Paraffin Wax | 34.5 |
| Montan Wax | 3.1 |
| Potassium Hydroxide | 0.5 |
| (45% solution) | |
| Total Weight | 100 |
| % Paraffin | 34.5% |

Adhesive properties of a DCF containing the no-PVOH paraffin wax emulsion in Table 9 was compared against the adhesive properties of a DCF containing a PVOH-encapsulated paraffin wax emulsion. The total amounts of polyvinyl alcohol in each case was made equivalent by post adding an equivalent quantity of polyvinyl alcohol to the DCF formula into which the no-PVOH paraffin wax emulsion was to be used. The DCF formulations evaluated are shown in Table 9.

TABLE 9
Adhesive Properties of Control and Inventive DCF

| Ingredients | 1 | 2 |
|---|---|---|
| Preservatives | 0.2 | 0.2 |
| Latex CPS 104 | 4.4 | 4.4 |
| Water | 38.3 | 38.3 |
| PVOH Encapsulated Wax Emulsion (33.5% | 2.4 | 0.0 |
| Paraffin) | | |
| Wax Emulsion, No PVOH (34.5% Paraffin) | 0.0 | 2.3 |
| Cellulose Ether | 0.6 | 0.6 |
| Polyvinyl Alcohol | 0.0 | 0.07 |
| Attagel 30 | 2 | 2 |
| Mica 4K | 6.4 | 6.4 |
| Microwhite 100 Calcium Carbonate | 36.5 | 36.5 |
| Perlite, SilCel 43-34 | 9.2 | 9.2 |
| Total Weight | 100 | 100 |
| Effective Paraffin Solids Content (g) | 0.80 | 0.79 |
| Effective Polyvinyl Alcohol Content (g) | 0.07 | 0.07 |
| Tape Bond Adhesion % | 100.0% | 30.0% |

In some embodiments, the DCF can provide water repellency. One indication of water repellency is the contact angle of a water droplet on the surface of the dried DCF. A water droplet surface that has a contact angle of less than 90 degrees would generally be considered hydrophilic (the smaller the contact angle the greater the hydrophilicity). Conversely, surfaces that cause a water droplet to have a contact angle greater than 90 degrees are generally considered hydrophobic. Commercially available ready mix DCF have contact angles of about zero degrees, meaning that a drop of water placed on such a surface will rapidly spread and wet out on the surface. Embodiments of the disclosed DCF can have a contact angle greater than about 60, 70, 80, 90, 100, 110, 120, or 130. In some embodiments, the DCF can have a contact angle between about 60 and 130, about 115 and 130, or about 118-120. Embodiments of the disclosed DCF, containing a wax emulsion, can have an average contact angle of about 98 degrees (based on an average of six measurements), or greater than about 98 degrees, indicating a hydrophobic surface.

In some embodiments, the contact angle can be between about 60 to about 110 degrees, or about 60, about 70, about 80, about 90, about 100, or about 110 degrees.

In some embodiments, the contact angel can be any number selected from the following numbers in degrees:

60, 61, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, and 130.

Low-Dust Products

Embodiments of the disclosed wax emulsion can be used to form many different dust control/water-resistant products. For example, embodiments of the wax emulsion can be incorporated into building materials such as asphalt (e.g., comprising a viscous liquid or semi-solid form of petroleum), concrete (e.g., comprising aggregate or filler, cement, water, various chemical and/or mineral admixtures, etc.), stucco, cement (e.g., formed from or comprising calcium carbonate, clay, gypsum, fly ash, ground granulated blast furnace slag, lime and/or other alkalis, air entrainers, retarders, and/or coloring agents) or other binders. In some embodiments, the wax emulsion can be incorporated into concrete cover coat formulations, such as those used for filling, smoothing, and/or finishing interior concrete surfaces, drywall tape, bead embedment, skim-coating, and texturing drywall. Further, embodiments of the wax emulsion can be incorporated into concrete and/or cement mixtures as a dust reducing additive. Therefore, embodiments of the wax emulsion can be incorporated into pourable concrete and/or cement that can be used, for example, for foundations in home constructions. Additionally, embodiments of the wax emulsion can be used in cinder blocks as well as other similar concrete or cement based products. In some embodiments, a low-dust/water-resistant building material can be formed with cement, wax emulsion, and silicone, or siloxane, or siliconate, or fluorinated compound, or stearate, or combinations thereof.

From the foregoing description, it will be appreciated that inventive devices and approaches for low-dust/water resistant products and wax emulsions have been disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination as well as in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the Drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount.

Some embodiments have been described in connection with the accompanying Drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using and medical applications for the same will be apparent to those of skill in the art. Accordingly, it should be understood that various applications, modifications, materials, and substitutions can be made of equivalents without departing from the unique and inventive disclosure herein or the scope of the claims.

What is claimed:

1. A method for controlling dust on a surface of a bulk material, comprising:
(I) preparing a dust control formulation (DCF) comprising a dust reduction additive (DRA) emulsion comprising colloidally-protected wax-based (CPWB) micro-structures; and
(II) applying said dust control formulation to said surface of said bulk material in an amount effective for dust control.

2. The method as recited in claim 1, wherein said dust control formulation is applied by sprinkling, and/or a spray nozzle.

3. The method as recited in claim 1, wherein said dust control formulation further comprises a first water.

4. The method as recited in claim 1, wherein said CPWB microstructure comprises:
(A) a wax core,
wherein said wax core comprises a paraffin component and a non-paraffin component,
wherein said paraffin component comprises at least one linear alkane wax defined by the general formula CnH2n+2, where n ranges from 13-80,
wherein said non-paraffin component comprises at least one wax selected from the group consisting of animal-based wax, plant-based wax, mineral wax, synthetic wax, a wax containing organic acids and/or esters, anhydrides, an emulsifier containing a mixture of organic acids and/or esters, and combinations thereof; and
(B) a polymeric shell,
wherein said polymeric shell comprises at least one polymer selected from poly-vinyl alcohol, polyvinyl alcohol copolymers, polyvinyl alcohol terpolymers, polyvinyl acetate, polyvinyl acetate copolymers, polyvinyl acetate terpolymers, cellulose ethers, polyethylene oxide, polyethyleneimines, polyvinylpyrrolidone, polyvinylpyrrolidone copolymers, polyethylene glycol, polyacrylamides and poly (N-isopropylamides), pullulan, sodium alginate, gelatin, starches, and combinations thereof.

5. The method as recited in claim 4, wherein said polymeric shell comprises polyvinyl alcohol.

6. The method as recited in claim 4, wherein said DCF further comprises a binder; a preservative; a rheology modifier; and/or a surfactant.

7. The method as recited in claim 4, wherein:
said binder is selected from polyvinyl acetate, polyvinyl alcohol, ethylene vinyl acetate co-polymer, vinylacrylic copolymer, styrenebutadiene, polyacrylamide, acrylic polymers, latex, natural starch, synthetic starch, casein, and combinations thereof.

8. The method as recited in claim 4, wherein said dust-reduction additive emulsion further comprises a second water; a base; and a dispersant.

9. The method as recited in claim 7, wherein said dispersant is selected from a dispersant having sulfur; a dispersant having a sulfur-containing group in the compound; sulfonic acid (R—S(═O)₂—OH); sulfonic acid salts, wherein the R groups is functionalized with hydroxyl, or carboxyl; lignosulfonate; lignosulfonic acid; naphthalene sulfonic acid; sulfonate salt of lignosulfonic acid; sulfonate salt of naphthalene sulfonic acid; derivatized lignosulfonic acid; derivatized naphthalene sulfonic acid; functionalized lignosulfonic ac-id; functionalized naphthalene sulfonic acid; magnesium sulfate; polycarboxylate; ammonium hepta molybdate; combination of ammonium hepta molybdate and starch; alkyl quaternary ammonium; montmorillonite clay; non-ionic surfactants; ionic surfactants; zwitterionic surfactants; and mixtures thereof.

10. The method as recited in claim 7, wherein said base is selected from monoethanol amine; diethanol amine; triethanol amine; imidazole; potassium siliconate; and combinations thereof.

11. The method as recited in claim 1, wherein the weight of said dust reduction additive emulsion is in the range of from about 0.01% to about 20% by weight of said dust control formulation.

12. The method as recited in claim 1, wherein the weight of said dust reduction additive emulsion is in the range of from about 0.1% to about 10% by weight of said dust control formulation.

13. The method as recited in claim 1, wherein said dust control formulation further comprises at least one component from a silicone, a siliconate, a fluorinated compound, a stearate, or a combination thereof.

14. The method as recited in claim 13, wherein the silicones, siliconates, fluorinated compounds, or stearates are selected from the group consisting of metal siliconate salts, potassium siliconate, poly hydrogen methyl siloxane, polydimethyl siloxane, stearate-based salts, and combinations thereof.

15. The method as recited in claim 1, wherein said dust control formulation is applied to the surface of said bulk material at the rate of from about 0.001 to about 5.0 gallon per square yard for controlling dust.

16. The method as recited in claim 1, wherein said bulk material is coal, limestone, fly ash, cement, carbon black, coke, or mineral material.

17. The method as recited in claim 1, wherein said bulk material is coal, and said dust control formulation is applied the top of said coal load in an open-topped, coal-hopper railcar, used for transporting coal.

18. A concentrated dust control formulation, suitable for dust control upon dilution with water consisting essentially of water and about 5-80% weight of dust control additive emulsion comprising colloidally-protected wax-based (CPWB) microstructures.
